(19) United States
(12) Patent Application Publication
(10) Pub. No.: US 2016/0377028 A1
(43) Pub. Date: Dec. 29, 2016

(54) CATALYTIC N2O PILOT IGNITION SYSTEM FOR UPPER STAGE SCRAMJETS

(71) Applicant: Reaction Systems, LLC, Golden, CO (US)

(72) Inventors: David Thomas Wickham, Boulder, CO (US); Bradley Dean Hitch, Golden, CO (US); Jeffrey Robert Engel, Golden, CO (US)

(73) Assignee: Reaction Systems, LLC, Golden, CO (US)

(21) Appl. No.: 14/272,273

(22) Filed: May 7, 2014

Related U.S. Application Data
(60) Provisional application No. 61/820,324, filed on May 7, 2013.

(51) Int. Cl. F02K 7/14; B64D 37/00; C01B 13/02; F02K 9/68; B01J 19/00; C01B 21/02

(52) U.S. Cl. CPC F02K 7/14; B01J 19/0013; C01B 21/02; C01B 13/0203; F02K 9/68; B64D 37/00; B01J 2219/00132; B01J 2219/00085; F05D 2220/323; F05D 2260/20; B64C 30/00

(57) ABSTRACT

There is disclosed a system including a catalytic heat exchanger reactor configured to carry out exothermic decomposition of stable chemical species possessing positive heats of formation. In an embodiment, the reactor is configured to enhance decomposition reaction rates by contacting gas entering with a hot surface. The catalytic heat exchanger is configured to receive N₂O and create N₂ and O₂. A torch is created by fuel together with the hot N₂ and the O₂. In an embodiment, the reactor is configured to, after an initial period of time, to allow a rapid transfer of products of the decomposition reaction into an engine. In an embodiment, the reactor is configured to enhance decomposition reaction rates by contacting gas entering with a hot surface, and the catalytic heat exchanger reactor is configured to promote the atomization and vaporization of liquid and gelled fuels with gas. Other embodiments are also disclosed.

### REFERENCE TO PENDING PRIOR PATENT APPLICATION

This application claims the benefit under 35 U.S.C. 119(e) of U.S. Provisional Patent Application No. 61/820,324, filed May 7, 2013 by David Thomas Wickham, et al., for “A CATALYTIC N₂O PILOT IGNITION SYSTEM FOR UPPER STAGE SCRAMJETS,” which patent application is incorporated herein by reference.

### GOVERNMENT LICENSE RIGHTS

This invention was made with Government support under contract #FA8650-10-C-2097 awarded by the Air Force. The Government has certain rights in the invention.

### BACKGROUND

Present designs for scramjet-powered hypersonic missiles employ simple rocket boosters to bring them up to minimum operating speeds where a dual-mode ram/scram engine can take over. However, the low air pressures and temperatures and the very short engine residence times make scramjet ignition at altitude difficult. Various methods to improve ignition and flame holding have been used with some success. However, all methods have limitations and therefore improved technologies are still needed.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Igniting upper stage hydrocarbon-fueled scramjets is very difficult because air temperatures are low and the fuel is not highly volatile. Therefore some type of ignition enhancer is needed to achieve reliable performance. One method that has good potential is to utilize the mixture of 33% O₂ and 66% N₂ produced from catalytic N₂O decomposition. N₂O decomposition is a very exothermic reaction, and the heat produced is sufficient to generate a product mixture that has temperatures of 1300° C. (2400° F.) and also contains a high concentration of O₂. Therefore the product mixture could be used to ignite a pilot torch for ignition or directly ignite the main combustor. The mixture could also be used to heat the fuel as a barbotaging agent. Catalyst formulations are identified that were active for N₂O decomposition into O₂ and N₂ under representative conditions. A catalytic heat exchanger/reactor is designed that is sized to support a pilot torch for use on a direct connect 2-D engine.

The effectiveness of the catalytic heat exchanger/reactor for N₂O decomposition and pilot torch ignition, culminating in a demonstration on a ground test scramjet was demonstrated at United Technologies Research Center (UTRC). It was demonstrated that combining a fuel with the mixture of hot products generated from the N₂O decomposition reaction results in immediate pilot torch ignition. Tests were conducted with gaseous ethane and liquid JP-7 fuels and used both gaseous and liquid phases of N₂O. In tests with JP-7, hot N₂O was used as a barbotage gas for the pilot torch fuel which produced very good fuel distribution and atomization. Finally, it was demonstrated that the pilot torch ignited a ground test scramjet engine with a nominal air flow of 10 lb/s at conditions equivalent to Mach 4.75 and Mach 5.0.

Other objects, features, and advantages of the invention will become apparent from the following detailed description of the invention with reference to the accompanying drawings.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates U.S. Standard Atmosphere variation of static temperature and pressure as a function of altitude.

FIG. 2 illustrates inlet stagnation air temperature versus flight Mach number for several dynamic pressures. Lines for H₂ and kerosene show temperature required for 1 ms igntion delay.

FIG. 3 illustrates N₂O supply system schematic and conditions for cold-soaked start.

FIGS. 4A-4D illustrate schematic views of the 1-in OD and ¾-in OD N₂O heat exchanger/reactors.

FIG. 5 illustrates photographs of the reactor.

FIGS. 6A-6D illustrate various views of the reactor, including an exploded view (FIG. 6A); views after coating with catalyst support (FIGS. 6B and 6C); and an assembled view (FIG. 6D).

FIG. 7 illustrates temperatures and JP-7 pressure measured in a torch ignition test with JP-7 and liquid N₂O with the ¾-in OD reactor.

FIG. 8 illustrates pressure and temperature data obtained in a test carried out at UTRC with a scramjet ground test engine at Mach 5.0 conditions.

FIG. 9 illustrates pressure and temperature data obtained in a test carried out at UTRC with a scramjet ground test engine at Mach 4.78.

FIG. 10 illustrates pilot torch and combustor pressures and temperatures plotted on the URTC time scale during a test at Mach 4.75, Q=2000 psf.

FIG. 11 illustrates the localized heating of the catalytic heat exchanger reactor at the end where N₂O first contacts the catalyst.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

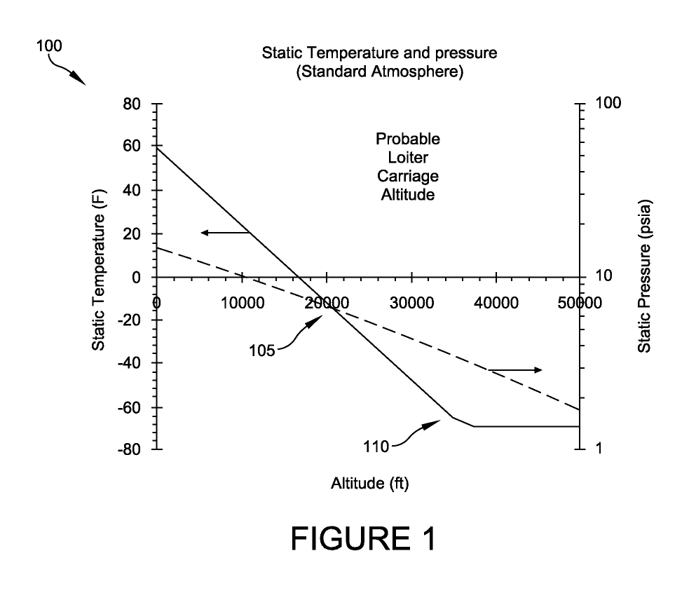

Aircraft with rapid global strike capabilities require hypersonic (Mach>5) flight to achieve their performance goals. Unfortunately, high-speed flight with air breathing vehicles presents a number of challenges, and therefore current designs for scramjet-powered hypersonic missiles employ simple rocket boosters to bring them up to a minimum operating speed where a dual-mode ram/scram engine can take over. Unfortunately, igniting scramjet engines and achieving stable operation at altitude is difficult. Low air pressure, low air temperatures, and short residence time all combine to make reliable ignition and stable flame holding a challenging problem. In addition, the engine components and the low volatility, distillate or endothermic fuel will be cold soaked prior to ignition. FIG. 1 illustrates a static temperature and pressure graph 100 with the temperature range 105, 110 expected during captive carry between −20 to −70° F. All of these conditions make it very difficult for the scramjet engine to start properly at the end of the rocket booster stage.

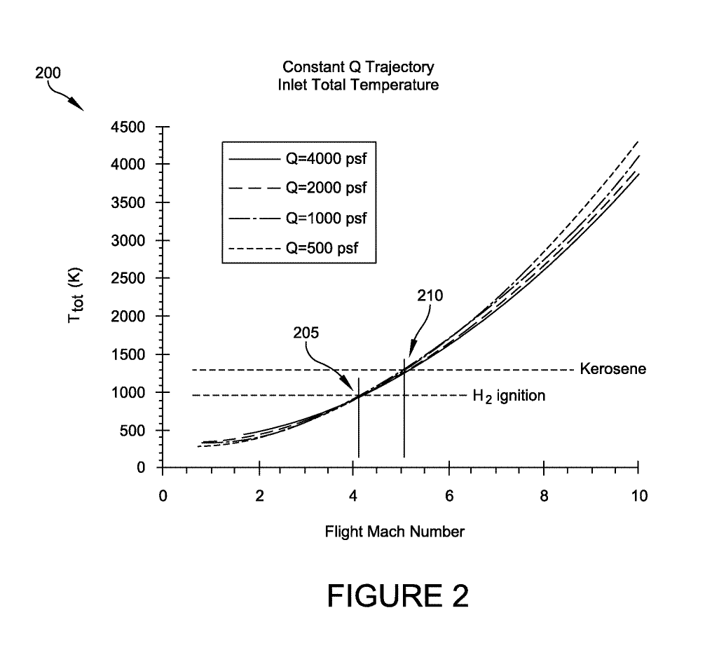

Ignition problems also affect the size of the rocket booster. Rough comparisons of rocket booster burnout Mach numbers required for hydrogen and kerosene-type distillate fuels can be made just on the basis of this residence time and the inlet total temperature using ignition delay time correlations. (Yu, G., Li, J. G., Chang, X. Y., Chen, L. H. and Sung, C. J., “Investigation of Kerosene Combustion Characteristics with Pilot Hydrogen in Model Supersonic Combustors,” J. Prop. Power, 17(6),1263-1272 (2001).) With reference to FIG. 2, a graph 200 illustrates inlet stagnation air temperature versus flight Mach number for several constant trajectories. Lines for hydrogen (H₂) and kerosene show temperature required for 1 ms ignition delay. In order to achieve a 1 ms ignition delay time for hydrogen, as shown at 205 a total temperature of about 1000 K is needed, which requires an initial speed of Mach 4. On the other hand, as shown at 210, to achieve the same ignition delay time with a kerosene fuel, a temperature of 1300 K is needed. This requires a burnout speed of Mach 5, which can only be achieved with a larger and more powerful rocket booster. Moreover, the speed will probably shift to even higher Mach numbers and inlet total temperatures while the hardware is warming up from the initial cold-soak condition and the fuel is still cold and atomization is poor. Therefore, finding ways to improve ignition could result in a lower required burnout Mach number and a smaller booster.

Effective ways to improve ignition and flame holding in a scramjet are essentially the same as those known to reduce ignition delay times. Smaller fuel droplets decrease ignition delay, therefore improved atomization through the use of effervescent atomization or barbotage improves ignition. Ignition aids including plasma igniters (Yu, G., Li, J. G., Chang, X. Y., Chen, L. H. and Sung, C. J., “Investigation of Kerosene Combustion Characteristics with Pilot Hydrogen in Model Supersonic Combustors,” J. Prop. Power, 17(6),1263-1272 (2001); and Niwa, M., Kessaev, K., Santana Jr., A., and Valle, M. B. S., “Development of a Resonance Igniter for GO₂/Kerosene Ignition,” Paper No. A00-36535 presented at the 36^{th} AIAA/ASME/SAE/ASEE Joint Propulsion Conference, Huntsville Ala., 16-19 Jul. (2000)), hydrogen pilot flames (Yu, G., Li, J. G., Chang, X. Y., Chen, L. H. and Sung, C. J., “Investigation of Kerosene Combustion Characteristics with Pilot Hydrogen in Model Supersonic Combustors,” J. Prop. Power, 17(6),1263-1272 (2001)), (Billingsley, M. C., O′Brien, W. F., and Schetz, J. A., “Plasma Torch Atomizer-Igniter for Supersonic Combustion of Liquid Hydrocarbon Fuels,” Paper No. AIAA 2006-7970 presented at the 14^{th} AIAA/AHI Space Planes and Hypersonics Conf. (2006)), (Jacobsen, L. S., C. D. Carter, T. A. Jackson, S. Williams, J. Barnett, C. J. Tam, R. A. Baurle, D. Bivolaru, and S. Kuo. “Plasma-Assisted Ignition in Scramjets”, Journal of Propulsion and Power, 24, pp. 641-654, (2008)) pyrophorics such as silane (Norris, R. B., “Freejet Test of the AFRL HySET Scramjet Engine Model at Mach 6.5 and 4.5,” Paper No. AIAA 2001-3196 (2001)), a combination of spark and plasma igniter (Mathur, T., K. C. Lin, P. Kennedy, M. Gruber, J. Donbar, T. Jackson, F. Billig, “Liquid JP-7 Combustion in a Scramjet Combustor,”AIAA-2000-3581, (2000)) and “Sugar Scoop” inlets (Jacobsen, L. S., C. J. Tam, R. Behdadnia, and F. Billig. “Starting and Operation of a Streamline-Traced Busemann Inlet at Mach 4,” AIAA-2006-4505, (2006).) have also been used with success. However, all of these methods have limitations and therefore new, improved methods are still needed.

Another way to improve scramjet ignition performance and avoid the drawbacks of the other ignition systems is to decompose nitrous oxide (N₂O) into a hot mixture of oxygen (O₂) and nitrogen (N₂) as shown in Reaction 1 below:

N₂O→N₂+½ O₂ ΔH=−802 Btu/lb Eqn. 1

As shown above, N₂O decomposition is a very exothermic process and can produce a mixture of 33% O₂ in N₂ with an adiabatic temperature of approximately 1300° C. (2400° F.). This mixture could be used to ignite a pilot flame for ignition of the main engine, to ignite the main engine, or finally as a source of hot gas used in a barbotage fuel injector. In addition, liquid N₂O also has some attractive physical properties. It has a relatively high density, over 60 lb/ft³ at temperatures expected at high altitude so it can be stored in a small tank. In addition, N₂O is capable of providing self-pressurization across the expected operational temperature range.

Unfortunately, there are two potential problems associated with the utilization of the chemical energy contained in N₂O. First, because N₂O is a relatively stable molecule, high temperatures are required for decomposition to occur. The second problem is that N₂O can also decompose into N₂ and NO. This is an endothermic reaction that does not produce oxygen.

It has now been demonstrated that utilizing a thermally stable, heterogeneous catalyst will solve both of these problems. (Wickham, D. T., Hitch, B. D, and Logsdon, B. W. (2010). “Development and Testing of a High Temperature N₂O Decomposition Catalyst,” Paper No. AIAA 2010-7128 presented at the 46th AIAA/ASME/SAE/ASEE Joint Propulsion Conference & Exhibit, 25-28 July, Nashville, Tenn.; and Hitch, B. D. and Wickham, D. T., “Design of a Catalytic Nitrous Oxide Decomposition Reactor,” Paper No. AIAA 2010-7129 presented at the 46^{th} AIAA/ASME/SAE/ASEE Joint Propulsion Conference & Exhibit, 25-28 July, Nashville, TN (2010).) It was shown that the catalysts prepared were very active for N₂O decomposition at temperatures as low as 325° C. (617° F.) and they were highly selective for O₂ and N₂, produced through the reaction shown in Eqn.1. On the other hand, in tests without catalyst, it was found that temperatures in excess of 850° C. (1760° F.) were required to achieve the same level of N₂O conversion. In addition when a catalyst was not present, much of the reaction proceeded by the endothermic pathway, producing high concentrations of NO and very little O₂. It was also shown that when the catalyst was attached to metal surfaces like those that would be used in a heat exchanger/reactor, it adhered very well. Finally, a catalytic heat exchanger/reactor was designed that would support a pilot torch for the direct connect 2-D engine. The reactor was designed for liquid N₂O flows of up to 0.19 lb/s and utilizes a small fraction of the heat generated in the N₂O decomposition reaction to vaporize the incoming liquid N₂O. The reactor may include two annular pathways, generated with a ½-in cartridge heater at the center, a ¾-in OD Inconel 600 liner, and a 1-in OD 316 stainless steel shell that contains the reaction pressure.

The heat exchanger/reactor may be used to decompose N₂O into a hot mixture of O₂ and N₂, which may be mixed with fuel in a pilot torch. The pilot torch may then be used to ignite a hypersonic combustor such as that found in a scramjet. The effectiveness of this system was demonstrated for the thermally stable catalyst, the heat exchanger/reactor in which the reaction was carried out, and the pilot torch that was used to ignite the scramjet engine.

N₂O Igniter System Design

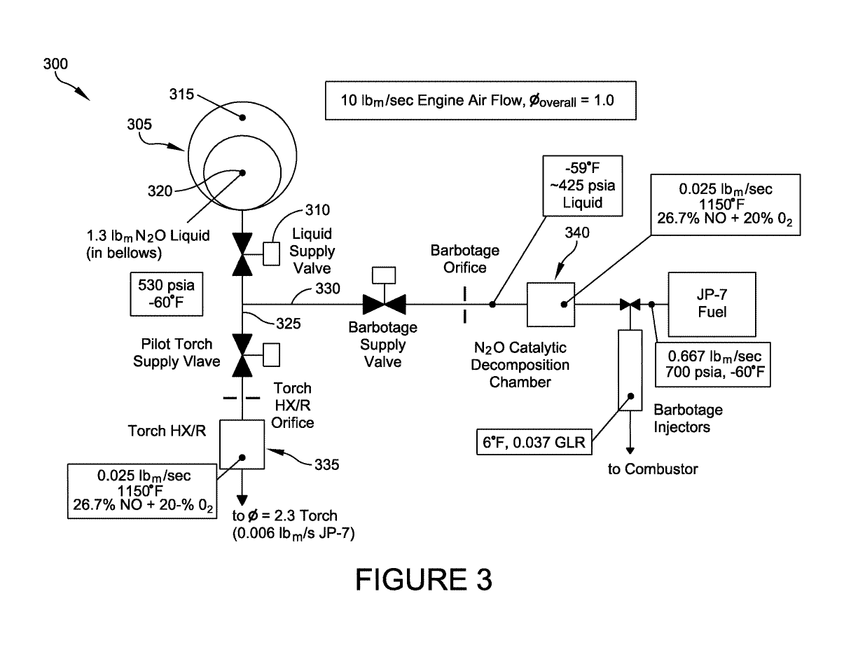

In work to demonstrate this concept, conceptual designs were first completed of an N₂O storage and delivery system and a catalytic heat exchanger/reactor (HX/R) N₂O system to supply hot gas for both barbotage fuel injectors and a pilot ignition flame. A nominal engine air flow of 10 lb/sec was used. FIG. 3 shows a schematic for the N₂O storage and delivery system 300. In this system the nitrous oxide is stored in a reservoir 305 as a compressed liquid and on/off valves and metering orifices 310, which provides rapid and accurate control and regulation of flow. Even though liquid N₂O has high vapor pressures at low temperatures, two phase flow could occur as the liquid passes through the metering orifices and drops pressure. To avoid this potential problem, a high pressure helium bottle (providing a helium pressurant 315) may be used to pressurize the N₂O liquid in its reservoir 305. The N₂O in the reservoir 305 is contained in a bladder or bellows which prevents dissolution of helium in the liquid and also allows liquid flow regardless of the vehicle orientation. The line connecting the high pressure helium bottle to the N₂O reservoir contains an on/off valve and a pressure regulator that will provide constant N₂O pressure during the course of the mission.

As shown, the system 300 contains separate N₂O flow paths for the pilot ignition torch path 325 and the barbotage supply path 330. Each flow is scaled to approximately 0.025 lb/s for a 10 lb/s engine. Each path contains an N₂O catalytic reactor 335, 340 that decomposes N₂O exothermically on the catalyst into O₂ and N₂. Electric heaters are contained in each reactor that warm the catalyst generating temperatures needed for the reaction to occur. Once the reaction starts, the exotherm generates much higher temperatures and heats the reactor substantially.

Current barbotage atomization systems have been provided with 500 psig air to assist in fuel atomization and injection into the combustor, so that value was specified here. Under the cold-soak conditions assumed in FIG. 3, the N₂O remains in the liquid state until it enters the HX/R 335, 340, where it is then boiled by the decomposition heat release. The mass flow rate of the resulting barbotage gas was assumed to be 4% by weight of the fuel flow. Mixing the hot barbotage gas with the cold fuel results in an overall fuel temperature rise of 60° F. in the absence of combustion. If some of the fuel combusts on contact with hot oxygen in the decomposed N₂O stream, the fuel/gas mixture temperature could be raised to 111° F., assuming only CO₂ and liquid H₂O are produced. This temperature rise would significantly improve fuel atomization and penetration performance compared to simply injecting very cold liquid fuel using a pressure atomizer.

Experimental Methods

Design of the Catalytic Reactors

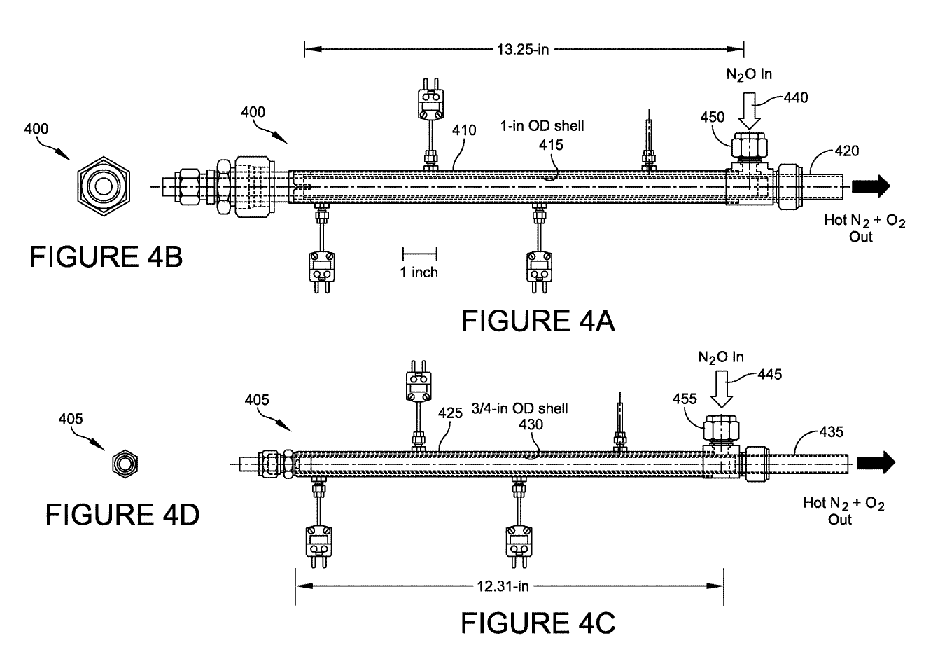

Two different sized double annular catalytic heat exchanger/reactors were used in this work. One reactor 400 has an outer shell that is one inch in diameter and the second reactor 405 has an outer shell that is ¾-in in diameter (FIG. 4).

The 1-inch reactor 400 includes a 1-in OD×0.065-in wall 316L stainless steel tube for the outer case 410, a ¾-in OD×0.065-in wall Inconel 600 liner 415, and a ½-in OD electrical cartridge heater 420 arranged concentrically, generating two concentric annular flow paths. The ¾-in OD reactor 405 includes a ¾-in×0.083-in wall 316L stainless steel tube that comprises the outer case 425. The liner is a ½-in OD×0.035-in wall Inconel 600 tube 430 while the cartridge heater 435 is ½-in OD. Both heaters are 1000 W and 240 V. The outer and inner annulus heights in the 1-in reactor are 0.060 and 0.062-in respectively and the total volume is 2.86 in³. The outer and inner annulus heights of the ¾-in reactor are 0.042-in and 0.0295-in and the total volume is 1.36 in³. At 400 psig and 400° C., N₂O has residence times of ˜0.082 seconds and ˜0.039 seconds in the 1-inch and ¾-inch OD reactors, respectively.

The inner and outer surfaces of the inside annulus (between the heater and the liners) are coated with a thermally stable N₂O decomposition catalyst, while there is no catalyst in the outer annulus. N₂O first enters the outer annulus where it is preheated as it travels down the length of the reactor (right to left in FIG. 4). It then reaches the end of the liner and is directed into the inner annulus where it contacts the catalyst that has been preheated with the cartridge heater, causing the N₂O decomposition reaction to occur as it travels down the length of the inner annulus (from left to right in the figure).

The reactors are designed to transfer heat from the inner annulus to the outer annulus, which both preheats the incoming N₂O 440, 445 and also controls the temperature of the catalyst. The N₂O inlet fittings 440, 445 on both reactors are modified Swagelok reducing tees. The cartridge heater in the 1-in reactor is sealed into the shell with a ¾-in VCR plug and Swagelok fitting, while the heater in the ¾-in OD reactor is sealed with a Swagelok fitting. The clearances in these reactors allow instrumentation of the units and capture of temperature profiles that can be used to tune the heat transfer model developed for this project. Four exposed bead thermocouples are used to measure the outer annulus gas temperatures, while up to five more thermocouples spot-welded to the outer surface of the case provide the temperature of the pressure containment shell.

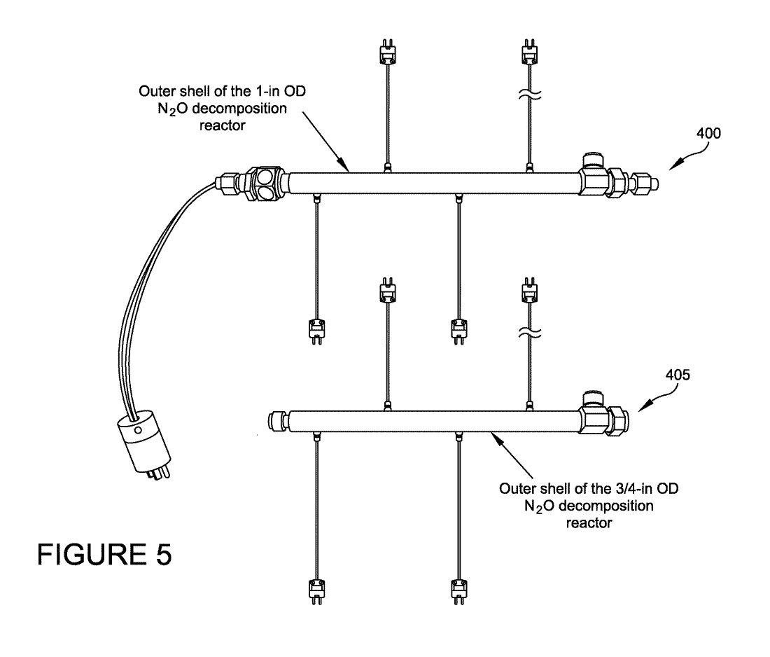

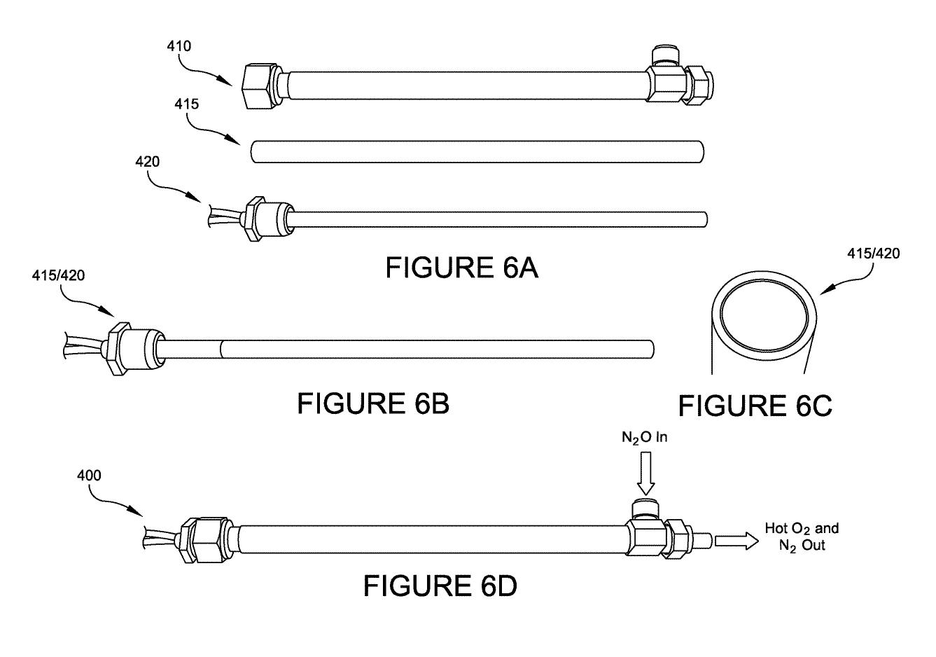

Photographs of the two reactors 400, 405 are shown in FIG. 5 and FIG. 6. FIG. 5 is a photograph of the 1-in OD and ¾-in OD reactors 400, 405, showing the difference in their relative sizes. FIG. 6 shows several photographs of the 1-in OD reactor 400: FIG. 6A shows the three individual reactor components, the 1-in OD outer shell 410, the ¾-in OD Inconel 600 liner 415, and the ½-in OD cartridge heater 420. FIGS. 6B and 6C show the cartridge heater 420 and the liner 415 after a coating of the catalyst support has been applied. The cartridge heater was then inserted into the liner, resulting in a configuration in which the catalyst was coated on both the inner and outer surfaces of the inner annulus. Finally, FIG. 6D shows the unit after it has been assembled.

Catalyst Preparation and Coating

Because the N₂O decomposition reaction generates very high temperatures, the catalyst used to accelerate the reaction and maximize selectivity to O₂ and N₂ must have excellent thermal stability. Typical catalyst supports such as alumina or silica are not stable at high temperature and therefore would not be usable catalyst supports. However hexaaluminates have been shown to have good thermal stability. A hexaaluminate consists primarily of Al₂O₃ with low concentrations of a transition metal such as barium, lanthanum, manganese etc. Therefore thermally stable catalysts were prepared by dispersing an active metal for N₂O decomposition on hexaaluminate supports. These catalysts have very good activity and also can withstand exposure to temperatures in excess of 1000° C. for many hours without loss in surface area. Therefore all catalysts used in the tests carried out are hexaaluminate-based materials. The catalyst was attached to the inside wall of the liners and the outer surfaces of the cartridge heaters. The typical layer thickness was between five and 15 microns. The length of the catalyst coating was varied on both the liner and the heater to tailor the area of catalytic heat release and avoid overheating of the external case at the hot end before the flow enters the inner annulus. Preventing the case from overheating allowed the reactor to operate for much longer periods of time and therefore yields more flexibility in the design of systems employing N₂O decomposition for various purposes. Control of the external case temperature by bringing it into intimate thermal contact with another heat sink, or through regenerative cooling using the incoming unreacted gas, liquid or two-phase N₂O flow are other additional alternatives that can be used. Heated N₂O may be tapped off anywhere along the outer annulus—reducing the flow rate through the inner annulus passage, or even add unreacted N₂O at various locations to tailor the axial temperature distribution of the reactor. Strategically locating the catalyst, such as by axial or circumferential striping or banding, also the location of the catalytic reaction and heat release to be varied in order to optimize overall performance. In addition, the stability of hexaaluminate catalyst supports even under full adiabatic equilibrium decomposition temperatures allows the reaction exotherm to be accessed under conditions that would destroy typical catalysts.

Tests to Demonstrate Pilot Torch Ignition with JP-7 and Liquid N₂O

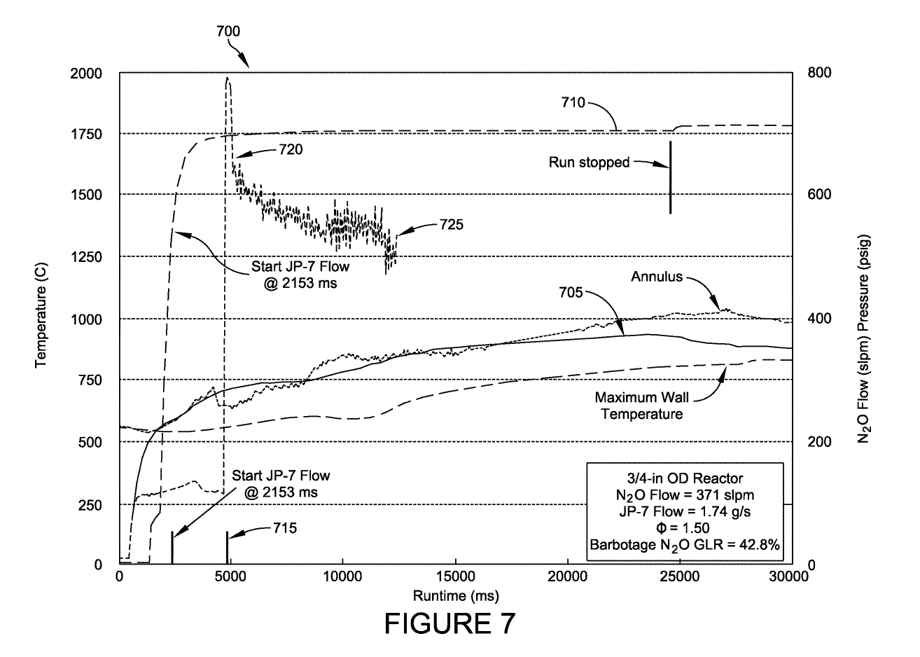

Tests were carried out in which the N₂O decomposition products produced in the catalytic heat exchanger were combined with fuel in a pilot torch. The results of one test are shown in graph 700 in FIG. 7. FIG. 7 shows that the temperature of the fluid exiting the reactor (reactor exit temperature 705) rises rapidly immediately after the N₂O flow is started. The N₂O flow is started at a time of 470 ms and the reactor exit temperature reaches 650° C. at a time of 3468 ms after only 3.0 seconds of N₂O flow. The fuel valves providing liquid fuel to the torch are opened at 2153 ms, as indicated by the small change in slope of the JP-7 pressure 710 and torch ignition 715 occurs at 4632 ms or only 2.5 seconds after the fuel flow was started. Much of that delay is the time required for the fuel to reach the fuel injectors in the torch. Finally, the temperature in the torch (torch exit temperature 720) initially is 1600° C. (2930° F.) and drops slowly to 1400° C. (2550° F.) after eight seconds of operation. At a run time of 12360 ms, after the torch had been ignited for approximately eight seconds, the thermocouple failed (TC failure at 725). However the torch remained ignited until the run was halted at 24332 ms or a total time of 19.7 seconds.

Ignition Tests with a Ground Test Scramjet Engine at UTRC

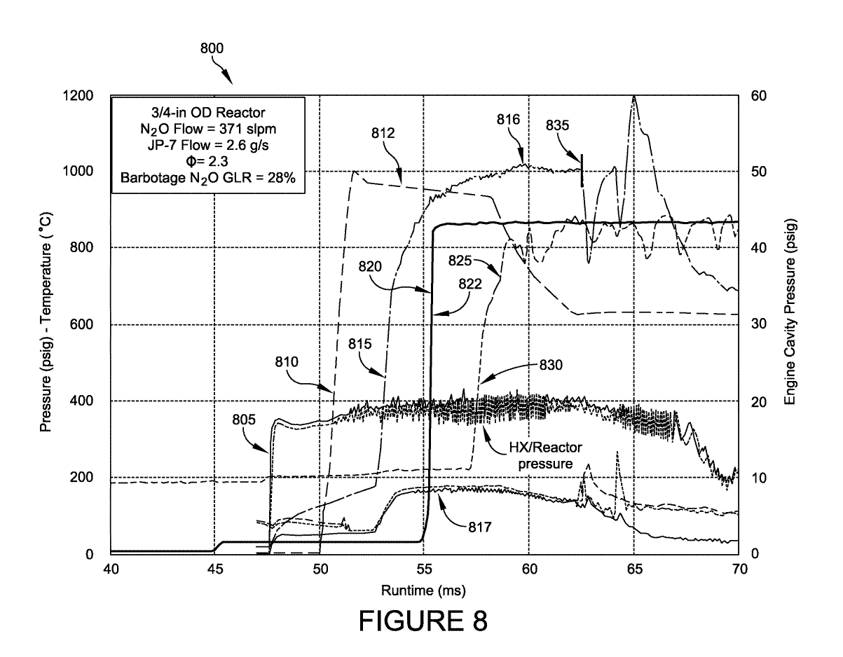

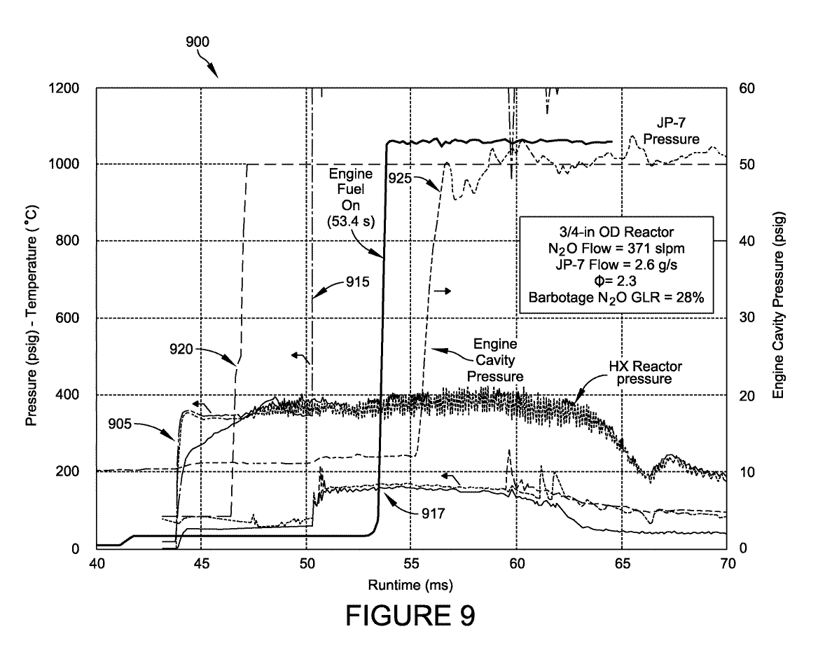

The N₂O delivery rig, heat exchanger/reactor, and torch assembly were shipped to the Jet Burner Test Stand (JBTS) at United Technologies Research Center (UTRC) in East Hartford, Connecticut for testing on a ground test scramjet engine with a nominal air flow rate of 10 lb/second. The torch was connected to the scramjet engine so that the flame penetrated into the top of the combustion cavity. Several tests were carried out with the engine simulating different engine ignition conditions. To conduct the tests, the cartridge heater in the catalytic heat exchanger/reactor was used to preheat the reactor. After preheating, the airflow to the scramjet engine was started, a hydrogen-oxygen torch was used to heat the air to the temperature representative of the desired Mach number, and air flow was started in the barbotage fuel injectors. When the engine walls reached 300° F., the pilot torch ignition process was initiated by starting the N₂O flow (FIG. 8; 805; FIG. 9, 905). Finally, when the pilot torch was ignited, fuel flow to the scramjet engine was started.

The results of these tests for Mach 5.2 conditions are shown in graphs 800, 900 in FIG. 8 and the results for Mach 4.85 conditions are shown in FIG. 9. Both figures show pressures and temperatures in the heat exchanger/reactor and torch assembly along with the fuel pressure and cavity pressure in the scramjet engine so that the timing of the events used to ignite the engine can be observed.

FIG. 8 shows that at a time of 47.6 seconds, the N₂O flow was initiated (at 805), which caused the pressures in the heat exchanger/reactor to increase rapidly to 375 psig. At 50.1 seconds (810) the torch ignition sequence was started, signaled by the rapid pressure increase (812) in the JP-7 fuel lines resulting from the pressurization of the JP-7 accumulator. At 52.7 seconds (815) the figure shows that the pilot torch temperature 816 and the pressures in the fuel injectors and torch 817 increased rapidly indicating that the torch had ignited. Once the torch was ignited, fuel to the scramjet was started at 55.2 s (820) as indicated by the rapid increase in the engine fuel pressure 822 from 30 psig to 860 psig. Finally at 57.6 seconds (825), the cavity pressure 830 in the engine increased rapidly from 11 psig to over 40 psig indicating that the scramjet ground test engine was ignited by the pilot torch. In addition to the cavity pressure 830, a video taken of the combustion chamber through a transparent window also provided clear visual evidence that the engine had ignited. After the engine was ignited, N₂O flow to the pilot torch was stopped 835.

The results presented in FIG. 8 show that the scramjet engine was ignited only 10.0 seconds after the N₂O flow was initiated (at 905) in the heat exchanger/reactor. Since the N₂O inventory represents additional weight that must be carried on the vehicle, reducing the time that N₂O flows before the engine ignites is desirable. Fortunately, the data show several delays that can be reduced either through changes in procedure or simple modifications in hardware. For example the fuel valve to the torch opened at 51.1 seconds, as indicated by the small spike in injector and torch pressures at that time. However, the fuel did not reach the torch until it 52.7 seconds, when it ignited, representing a delay of 1.6 seconds for fuel to travel from the on/off valve to the torch injector. In addition, after the torch ignited at 52.7 seconds, the fuel to the main engine was not started until 55.2 seconds, a procedural delay of 2.5 seconds. Thus, making simple changes in the torch fuel lines and start up procedures could reduce the time required for the engine to ignite after N₂O flow is started by up to four seconds, or by 40%.

The results for the Mach 4.78 case are shown in FIG. 9. Overall, they are similar to the results presented in the previous figure but there is a slightly longer delay between the time N₂O flow started and when the engine ignited. In this case N₂O flow was started at 43.8 seconds (905) and the engine did not ignite until 55.4 seconds (925), a delay of 11.6 seconds. However in this case there are two time periods between events that are longer than in the previous test that can be reduced with procedural modifications. For example, the pilot torch ignited at 50.3 seconds (915) or 3.9 seconds after the ignition sequence was started, which is 1.3 seconds longer than was required in the previous test. This figure shows that the fuel valves were opened at 47.4 seconds as evidenced by the small spike in injector pressures. Although fuel reached the injectors at 48.6 seconds, as evidenced by the small increase in the pressures 917 of both injectors, the torch did not ignite immediately as it had in the previous test. Instead it took another 1.7 seconds before the torch ignited in this test. Once the torch was ignited, the main engine fuel flow was not started until 53.4 seconds (920), a delay of 3.1 seconds, which is 0.6 seconds longer than the delay in the previous test. Fortunately, both of these delays can be reduced substantially. The additional time required to ignite the pilot torch was likely due to the initial N₂O flow that overshot the desired flow in the first few seconds of the test. This reduced the equivalence ratio in the pilot torch, which increased the time required to ignite. In addition, starting the fuel in the main engine was done manually and therefore automating this step so that it is triggered by a parameter in the pilot torch could reduce this time substantially.

Ignition Test at Nominal Mach 4.75, Q=2000 Conditions

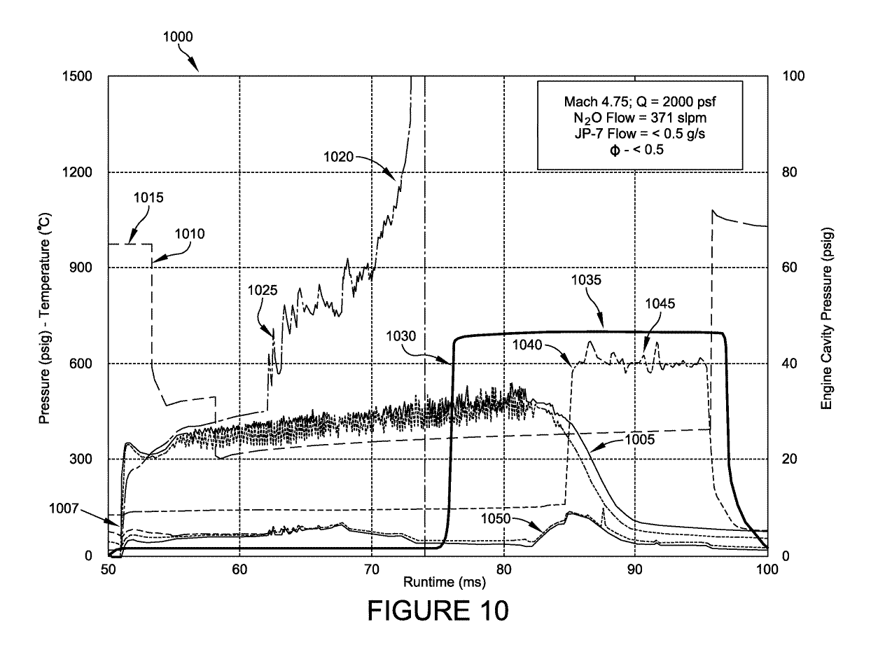

With reference to FIG. 10, a plot 100 illustrates pilot torch and combustor pressures and temperatures on the UTRC time scale as results of a test at Mach 4.81 and at Q=2390 psf conditions. In this test, there was an unintended interruption in the JP-7 flow to the pilot torch caused by an operator error where a secondary fuel valve was not opened as planned during the torch ignition sequence, and therefore there was very little fuel flow to the torch.

FIG. 10 shows the data obtained in this test. The heat exchanger pressure increased sharply at 51.3 seconds (1007) indicating the start of our N₂O flow. At 53.3 seconds (1010), the temperature of the fluid exiting the heat exchanger was high enough (over 600° C.) to open the JP-7 valve to our torch. Under normal circumstances, opening the JP-7 valve would cause a fluctuation in the JP-7 pressure 1010 but the pressure 1015 would ultimately return to the original value, about 1000 psi. However in this case, the pressure 1015 dropped because the upstream valve was not opened. The small amount of fuel that did reach the torch caused the torch temperature 1020 to increase beginning at 62.1 seconds (1025). However, the rise was much slower than in all other tests. Because a torch flame was visible, the main engine fuel flow to the combustor was started manually at 75.6 seconds (1030) as indicated by the increase in main engine fuel pressure 1035. Finally at 84.6 seconds (1040), the engine cavity pressure 1045 increased indicating that the engine did ignite. In this test, the N₂O decomposition reactor operated for 33.3 seconds without overheating.

Given the fact that the pilot torch did not ignite properly due to the lack of fuel flow, it is somewhat surprising that the main engine did ignite. However the data in FIG. 10 can provide a potential cause for the ignition. The figure shows that at about 82 seconds, the pressure 1005 in the heat exchanger began to decrease and at the same time, the pressure in the torch body 1050 began to rise. This was caused by the erosion of the choked flow venturi that separated the heat exchanger/reactor from the torch, which allowed a surge of gas into the torch and the scramjet engine. FIG. 10 shows that the engine ignited at the same time the heat exchanger was losing pressure, which was causing a surge of gas flow into the engine. These results suggest that this transient gas flow into the scramjet engine contributed in some way to the engine ignition.

These results suggest that it may be possible to ignite the engine without a pilot torch. Designing an N₂O decomposition reactor that operates for a short time at high pressure and then rapidly dump hot N₂O decomposition products into the engine may provide a reliable way to ignite the engine without a pilot ignition torch.

Catalytic Versus Thermal N₂O Decomposition

N₂O can also decompose in the gas phase and because this reaction produces NO, it is much less exothermic. Previously, it was believed that the thermal decomposition reaction was unlikely to be useful and the catalytic decomposition route would dominate. However evidence was obtained over the course of the work that indicated the thermal decomposition reaction was contributing significantly to the overall product distribution under some conditions.

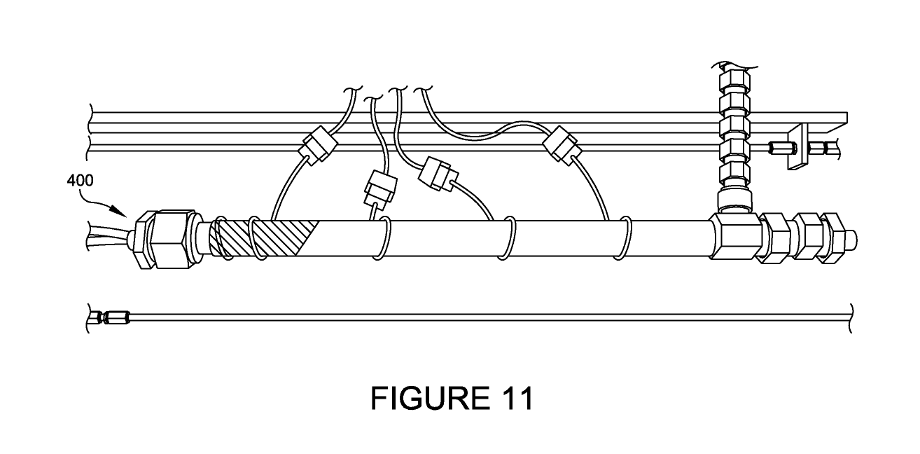

In the initial design of the N₂O decomposition reactor, a 1-inch OD shell was selected based on an N₂O flow rate that was approximately six times greater than the flow that was ultimately used to ignite the combustor at UTRC. As a result, the flow passage areas and annulus heights were much larger than desired for the lower flows that were used. Dropping the N₂O flow by a factor of six therefore resulted in much lower Reynolds numbers and surface heat and mass transfer coefficients, and much longer fluid residence times, than envisioned—though at least still in the fully turbulent regime. In initial tests with the 1-in OD reactor, a very repeatable, localized heating pattern was observed at the point where the N₂O flow first contacted the catalyst. A typical result is shown in FIG. 11, which shows a high wall temperatures at the location where the preheated N₂O turns to enter the inner catalyzed annulus passage. Heat transfer and thermodynamic analysis of the test data indicated that the measured temperatures and flow rates could only be reconciled if most of the N₂O were being decomposed thermally in the gas phase to produce on the order of 30% NO in the exit stream. The effect of the gas phase reaction was reduced in tests with the ¾-in OD reactor, which has much smaller flow passages and lower fluid residence times. In addition, catalyst was not coated on the entire length of the inner annulus but instead the first inch or two of both sides of the annulus were not coated. These changes reduced the rapid increases in the case temperature and this reactor was able to run for 30 seconds or more at a time.

In this configuration, the thermal decomposition of N₂O contributes to the heat generation but can be controlled on the hot liner surface in the outer annulus flow passage. Heating of the outer annulus flow not just through heat transfer from the inner annulus but also due to N₂O thermal decomposition and heat release in the gas layer near the hot liner surface results in much more rapid heating of the outer annulus flow—and therefore much reduced heat transfer surface area requirements - than originally anticipated during design of the heat exchanger reactor. Since minimizing mass and volume is paramount in flight systems, this unique insight is both very useful and not obvious, even to those skilled in the art.

The results obtained to date demonstrate the feasibility of using catalytic N₂O decomposition on board a vehicle both as a pilot ignition system and as a source of gas for barbotage fuel atomization. It was demonstrated that combining JP-7 with the hot products produced from N₂O decomposition in a pilot torch results in immediate torch ignition. The effectiveness of the catalytic heat exchanger/reactor as a source of hot N₂O for use as a barbotage gas was also demonstrated. Several tests were carried out in which the pilot torch ignited a ground test engine scram jet engine at air flows of approximately 10 lb per second. In addition, in one test in which the ignition torch did not receive fuel, the main engine still ignited due to the transient flow of hot N₂O and decomposition products that entered the engine because the orifice downstream of the reactor failed.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A system comprising a catalytic heat exchanger reactor configured to carry out an exothermic decomposition of stable chemical species possessing positive heats of formation, and the catalytic heat exchanger reactor configured to enhance decomposition reaction rates by contacting the gas entering the reactor with a hot surface generated by the exothermic decomposition of stable chemical species during regenerative heat transfer.

2. The system of claim 1 wherein the catalytic heat exchanger is configured to receive N₂O and creates N₂ and O₂.

3. The system of claim 2 further comprising a torch created by fuel and the hot N₂ and the O₂ from the catalytic heat exchanger.

4. The system of claim 1 wherein the catalytic heat exchanger reactor includes a thermally stable catalyst coated on the reactor walls that bound the annular flow paths in the reactor.

5. The system of claim 4 wherein the thermally stable catalyst is active at a temperature over 350° C.

6. The system of claim 4 wherein a location and quantity of the catalyst is adjustable to optimize the balance obtained between catalytic decomposition of N₂O and the gas phase decomposition reaction.

7. The system of claim 6 wherein the fuel is a distillate hydrocarbon or endothermic fuel.

8. The system of claim 6 further comprising a scramjet engine configured to receive a flame from the torch, wherein the scramjet engine and the torch are configured to allow the torch to light the scramjet engine.

9. The system of claim 1 wherein the reactor operates at a pressure greater than 100 psi.

10. The system of claim 1 wherein the reactor is configured to operate for an initial period of time, and after the initial period of time, the reactor is configured to allow a rapid transfer of products of the decomposition reaction into an engine.

11. The system of claim 10 wherein the engine is configured to ignite due to the rapid transfer of the products of decomposition therein.

12. The system of claim 10 wherein the engine is a ramjet engine.

13. The system of claim 10 wherein the engine is a scramjet engine.

14. The system of claim 10 wherein the engine is configured to provide a combustion-augmented event using a small amount of fuel or oxidizer to increase the temperature of the gas during the rapid transfer of the products of decomposition.

15. The system of claim 14 wherein the ramjet engine is configured for ignition with the combustion-augmented event together with the rapid transfer of the products of decomposition therein.

16. The system of claim 14 wherein the scramjet engine is configured for ignition with the combustion-augmented event together with the rapid transfer of the products of decomposition therein.

17. The system of claim 1 wherein the catalytic heat exchanger reactor is configured to promote the atomization and vaporization of liquid and gelled fuels with the gas generated by the exothermic decomposition of the stable chemical species.

18. The system of claim 2 wherein the N₂ and O₂ generated from the N₂O is an oxidizer-rich gas, wherein the gas generated is configured to promote atomization and vaporization of at least one of liquid fuel and gelled fuel.

19. The system of claim 18 wherein the catalytic heat exchanger reactor and an engine are configured to allow the oxidizer components of the gas to combust with part of the fuel to increase temperature of the at least one of liquid fuel and gelled fuel, and wherein the catalytic heat exchanger reactor and the engine are configured to enhance atomization of at least one of liquid fuel and gelled fuel.

20. The system of claim 1 wherein the catalytic heat exchanger reactor is configured to extract fluid from an outer passage to provide warm, pressurized gas for an ancillary process.

21. The system of claim 20 wherein the ancillary process is electric power generation.

22. The system of claim 20 wherein the ancillary process is effervescent atomization of fuel.

23. The system of claim 20 wherein a flow rate of the fluid extraction from the outer passage is varied to control at least one of catalyst surface temperature and reactor exit gas temperature.

24. The system of claim 1 further comprising a turbine-generator for the generation of electrical power.

25. The system of claim 1 further comprising a gas pressurization supply.

26. The system of claim 1 further comprising a gas-driven hydraulic pump.

27. The system of claim 1 further comprising a source of oxygen that can be utilized for the production of electrical power in a fuel cell.

28. A system comprising a catalytic heat exchanger reactor configured to carry out an exothermic decomposition of stable chemical species possessing positive heats of formation, and the catalytic heat exchanger reactor configured to enhance decomposition reaction rates by contacting the gas entering the reactor with a hot surface generated by the exothermic decomposition of stable chemical species during regenerative heat transfer, the catalytic heat exchanger configured to receive N₂O and create N₂ and O₂, and a torch created by fuel together with the hot N₂ and the O₂ from the catalytic heat exchanger.

29. A system comprising a catalytic heat exchanger reactor configured to carry out an exothermic decomposition of stable chemical species possessing positive heats of formation, and the catalytic heat exchanger reactor configured to enhance decomposition reaction rates by contacting the gas entering the reactor with a hot surface generated by the exothermic decomposition of stable chemical species during regenerative heat transfer, and the reactor configured to operate for an initial period of time, and after the initial period of time, the reactor configured to allow a rapid transfer of products of the decomposition reaction into an engine.

30. A system comprising a catalytic heat exchanger reactor configured to carry out an exothermic decomposition of stable chemical species possessing positive heats of formation, and the catalytic heat exchanger reactor configured to enhance decomposition reaction rates by contacting the gas entering the reactor with a hot surface generated by the exothermic decomposition of stable chemical species during regenerative heat transfer, and the catalytic heat exchanger reactor configured to promote the atomization and vaporization of liquid and gelled fuels with the gas generated by the exothermic decomposition of the stable chemical species.
